(19) United States
(12) Patent Application Publication
(10) Pub. No.: US 2006/0197279 A1
(43) Pub. Date: Sep. 7, 2006

(54) Gaming machine with second display

(76) Inventors: Toshiaki Shimizu, Tokyo (JP); Ichiro Tsuchida, Chatswood (AU); Peter Etridge, Randwick (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/533,187

(22) PCT Filed: Oct. 31, 2003
(86) PCT No.: PCT/AU03/01432

§ 371 Date: Apr. 3, 2006

(30) Foreign Application Priority Data
Oct. 31, 2002 (AU) 2002952395

(51) Int. Cl. A63F 13/00; A63B 71/00

(52) U.S. Cl. 273/143 R; 463/20

(57) ABSTRACT

A gaming machine operable to play a base game and a second game; the gaming machine including a first display adapted to display progress and results of the base game; the gaming machine further including a second display adapted to display progress and results of the second game; the base game and the second game arranged to be played such that selected ones of outcomes of the second game affect play of the base game, whilst the outcome of the second game is independent of the outcome of the base game.

The present invention relates to a gaming machine of the “poker machine” type and having more than one display.

### BACKGROUND

Electronic gaming machines, sometimes and particularly in earlier times termed slot machines or poker machines, have been implemented via electro-mechanical reel arrangements. In more recent times the electro-mechanical reels have been replaced with video monitors of various kinds which simulate visually the reels of the electro-mechanical reel machines.

The use of video monitors and the like has improved the graphical appeal of games played on the gaming machines to the point where it can be difficult to differentiate games, one from the other.

It is an object of embodiments of the present invention to address or ameliorate at least one of the above mentioned disadvantages.

### BRIEF DESCRIPTION OF INVENTION

Accordingly, in one broad form of the invention, there is provided a gaming machine operable to play a base game and a second game; said gaming machine including a first display adapted to display progress and results of said base game; said gaming machine further including a second display adapted to display progress and results of said second game; said base game and said second game arranged to be played such that selected ones of outcomes of said second game affect play of said base game, whilst the outcome of said second game is independent of the outcome of said base game.

Preferably said base game and said second game are initiated substantially simultaneously.

Preferably a win conferred by said second game can award one or more of the following directly to said base game:
i. A nil result;
ii. A cash jackpot award;
iii. An award of a re-spin;
iv. An award of credits for use in subsequent games;
v. A feature game on the base game;
vi. Free games or bonus game on said base game;
vii. An award of base game symbols in conjunction with a re-spin of the base game.

Preferably a win conferred by said second game can award a feature game to be played in said second display the outcome of which can award one or more of the following to said base game:
i. A nil result;
ii. A cash jackpot award;
iii. An award of a re-spin;
iv. An award of credits for use in subsequent games;
v. A feature game on the second game;
vi. Free games or bonus game on said base game;
vii An award of base game symbols in conjunction with a re-spin of the base game.

Preferably said base game is a symbol-driven game.

Preferably said second game is a symbol-driven game.

Preferably the coming to rest of symbols of said first game is sequentially controlled.

Preferably the coming to rest of symbols of said second game is sequentially controlled.

Preferably sequencing of progress of said second game is interleaved with sequencing of progress of said first game.

Preferably said second game is paused when a winning combination of the second game is approached.

Preferably said second game remains paused until said base game terminates.

Preferably said play of said base game comprises a play of an initial game together with a play of any awarded feature games or bonus games or the like.

Preferably said base game includes an array of either 3 or 4 or 5 or 6 reels.

Preferably said second game includes a three reel array together with a fourth reel adapted to display an openable aperture.

Preferably each reel of the reels of said three reel array is divided into a number of sectors displayed on the circumferences of each said reel and wherein each said reel is provided with a symbol in at least one of said sectors.

Preferably a winning combination for said second game occurs when three symbols are aligned on a centre line of said three reel array and any symbol is displayed in said openable aperture of said fourth reel.

Preferably a win is determined according to a predetermined disposition of said symbols of said three reel array when said three reel array has reached a stationary state at the end of said second game.

Preferably the five reels of said base game and the reels of said second game are induced to spin at the start of said base game, and said openable aperture of said second game opens to reveal a symbol.

Accordingly, in a further broad form of the invention, there is provided a gaming machine of any previous claim wherein a feature game is awarded thereon and has its progress and outcome displayed on said first display; said feature game having an increased probability of award as a result of initiation of a play of both said base game and said second game substantially simultaneously as compared with initiation of said base game only.

Accordingly, in yet a further broad form of the invention, there is provided a method of increasing probability of an award of a feature game, said method comprising:
a) Providing a base game and a second game on an Electronic Gaming Machine together with a first display for displaying progress and results of said base game and a second display for displaying progress and results of said second game;
b) Causing a play of said second game to be triggered when a play of said base game is initiated.
c) Allowing selected ones of outcomes of said second game to affect play of said base game whilst the outcome of said second game is maintained independent of the outcome of said base game.

### BRIEF DESCRIPTION OF THE DRAWINGS

Embodiments of the present invention will now be described with reference to the accompanying drawings wherein:

FIG. 1 is a perspective view of a gaming machine with a simultaneous play feature according to a first preferred embodiment of the invention,

FIG. 2 is a view of the elements of a second game display usable in conjunction with the gaming machine of FIG. 1,

FIG. 3 is a flow chart of the interaction of a base game with a second game in accordance with a particular embodiment of the present invention usable in conjunction with the machine of FIG. 1, and

FIG. 4 is a view of the elements of a base game and second game in accordance with a first example of an embodiment of the present invention.

### DETAILED DESCRIPTION OF PREFERRED EMBODIMENTS

In this specification the term “outcome” is used interchangeably with the word “result” to denote the end result or final outcome of a particular game play, whether a base game or a second game. For example, if the gate rules denote the win of a feature game or an award of credits if three King symbols together with any two other symbols appear in a straight line on a simulated reel display then in the instance where three Kings together with any two other symbols appear in a straight line (thereby, according to the rules, resulting in the award of a feature game or credits) then this award represents an “outcome” or “result” of that particular game in accordance with those particular rules.

In this specification the term “probability of a win” or a “player's winning chance” denotes, in accordance with the rules of probability theory, the probability of a particular outcome or result for any given game in accordance with the rules applying to that particular game.

In this specification the term “progress” applied to a game denotes that period of time between the initiation of a play of the game and the termination of the play of the game. Typically, in the case of a symbol-driven game, a player is presented with some indication that the game is progressing towards its termination, for example by showing simulated reels of spinning symbols or other indications of animation on a display.

In this specification “game” is used in the context of games played on an electronic gaming machine. A game can be initiated by a player or can be initiated as the result of an outcome of a game initiated earlier. Each game includes a termination phase during which a result or outcome of the game is made known to a player, typically visually or audibly or both.

In this specification the term “symbol-driven game” refers to a game where a plurality of symbols are presented consecutively to the player during progress of a game in a way which permits the player to identify the symbols. This arrangement, in effect, reports visually on the progress of the game to the player as the game progresses. This arrangement is to be contrasted with what are sometimes called “mystery” games wherein there is no continuous reporting of progress of a game but only report of an outcome as and when the outcome occurs.

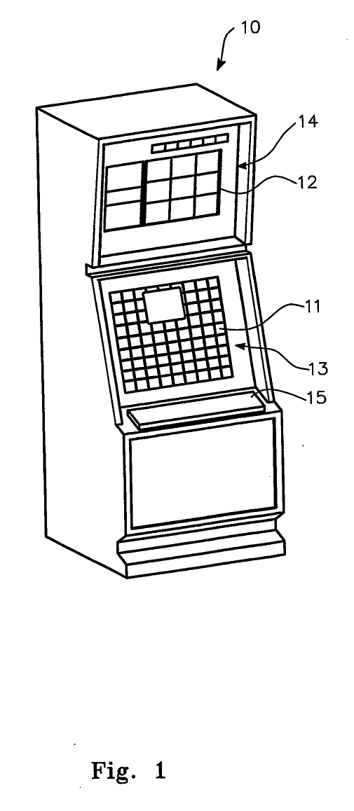

With reference to FIG. 1 a gaming machine 10 incorporating a simultaneous play feature in accordance with particular embodiments of the present invention will now be described.

The gaming machine 10 in this instance, comprises a first display 11 above which is located a second display 12.

First display 11 is adapted to display the progress and result of a base game 13 whilst second display 12 is adapted to display the progress and outcome of a second game 14.

In this instance base game 13 and second game 14 are arranged to be played simultaneously. That is second game 14 starts automatically as and when the base game 13 is initiated by a player (not shown).

The outcome of the second game 14 is independent of the outcome of the base game 13, whilst the outcome of the base game 13 is dependent (in part) on the outcome of the second game 14, the dependency coming in the following forms by way of non-limiting example: bonus games being awarded to the base game based on certain outcomes of the second game; triggering of base game features based on certain outcomes of the second game; triggering of re-spin games on base game based on certain outcomes of the second game; symbols or multipliers being added to the base game based on certain outcomes of the second game.

The base game 13 in this preferred embodiment is a typical five reel poker machine game that can include features such as re-spins, free games, bonus games, second screen features (embedded in the first display II) and the like.

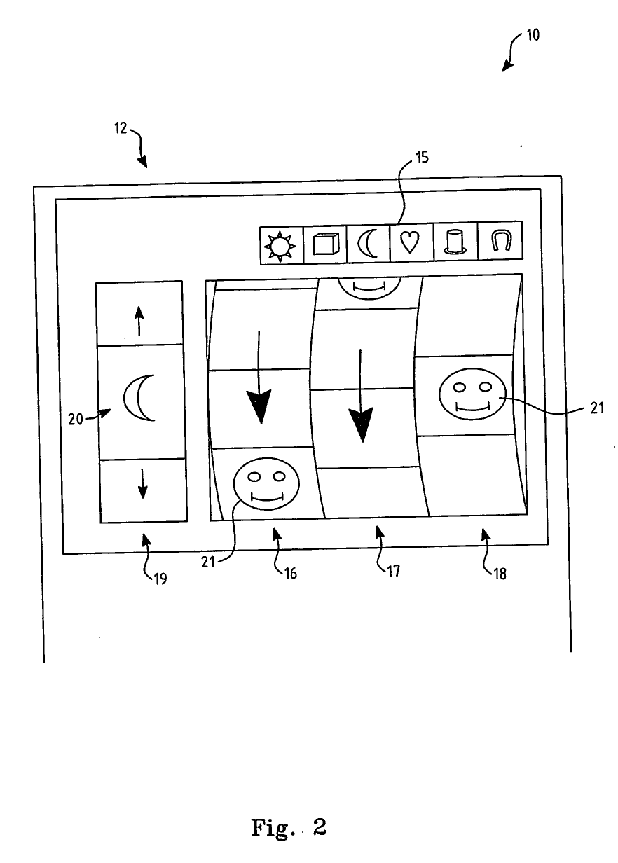

As shown in FIG. 2, in this preferred embodiment the second game 14 involves three spinning reels 16, 17 and 18 and a fourth reel or “magic door” 19; When the second game starts (at the commencement of the base game) the magic door 19 opens to reveal either a blank space or a randomly selected symbol 20 indicative of the benefits and prizes that may be conferred by a favourable outcome of the play of the second game; a blank space indicating a nil benefit.

Concurrent with the start of the base and second games, the three reels 16, 17 and 18 start to spin. Each of these reels is divided into a number of sectors at least one sector of which on each reel is provided with a reel symbol 21. All three reels carry an identical set of symbols in this preferred embodiment.

The function of the symbols on the three reels is to determine if the player of the main game is to be awarded a prize.

If matching reel symbols 21 appear on the center line of each reel when the reels 16, 17 and 18 come to rest and a symbol 20 is displayed in the magic door 19 indicative of a prize, the player may be awarded a prize in accordance with the symbol displayed in the magic door 19.

The prize may directly award credits to the player win meter or directly award bonus games, re-spins, additional symbols, multipliers, or features to the base game 13. Alternatively the prize may award a feature to be played on the second display, the outcome of which may award credits to the player win meter or award bonus games, re-spins, additional symbols multipliers, or features to the base game 13.

A distinguishing feature of the second game in this instance lies in the nature of the prizes awarded by the second game.

For example, if a win were to be translated into credits which are transferred to the credit meter on the main display of the base game, this would merely give a player the opportunity to claim a larger win or to continue playing the base game with the additional credits but does not in any way affect the outcome of the base game itself.

By contrast, in this embodiment the second game 14 can award free games of the base game or trigger the embedded second screen feature in the base game, thereby affecting in a manner beneficial to the player the probability of positive outcomes in the base game for a given investment in credits bet on gaming machine 10.

As a means of heightening player anticipation and excitement during the progress of the base and second games, the sequence of simulated reels coming to rest is coordinated between the second and base games. The intention of this sequence co-ordination is to give a progressively updated indication to the player of the progressive probability of a win or prize award as an outcome of the second game.

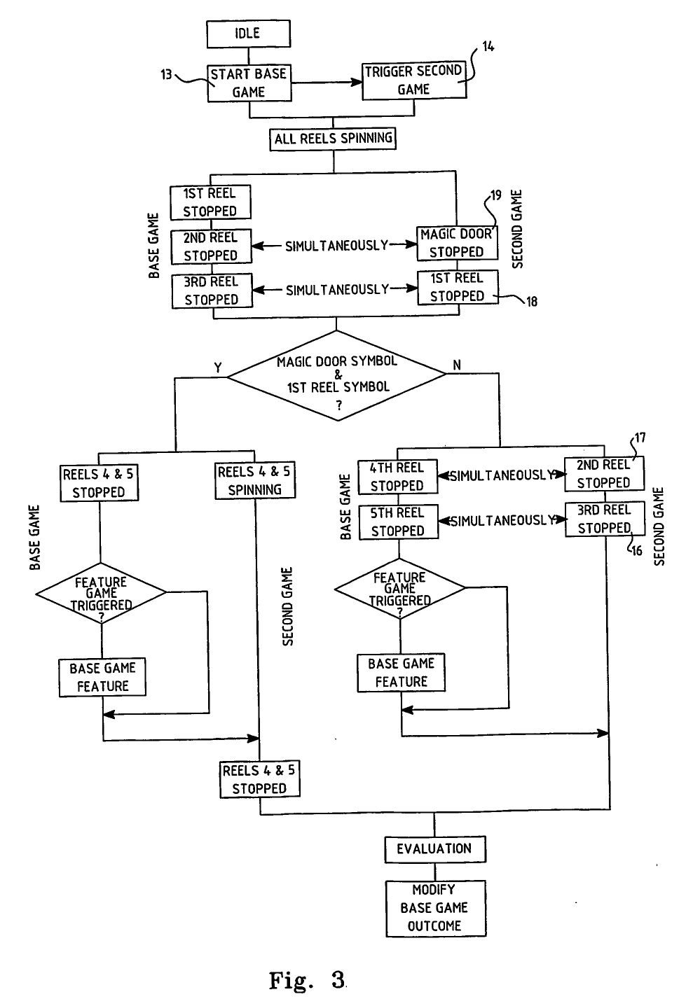

To this end play on the second game is paused when a winning combination of the second game is approached, for example when the first reel 16 comes to rest displaying symbol 21 on the center line. A distinctive sound or jingle is emitted to alert the player to this condition and the secondary game remains paused until the base game and any base game features are finished. A flowchart of progress for the base and second games is illustrated in FIG. 3 in accordance with this preferred embodiment.

### EXAMPLE 1

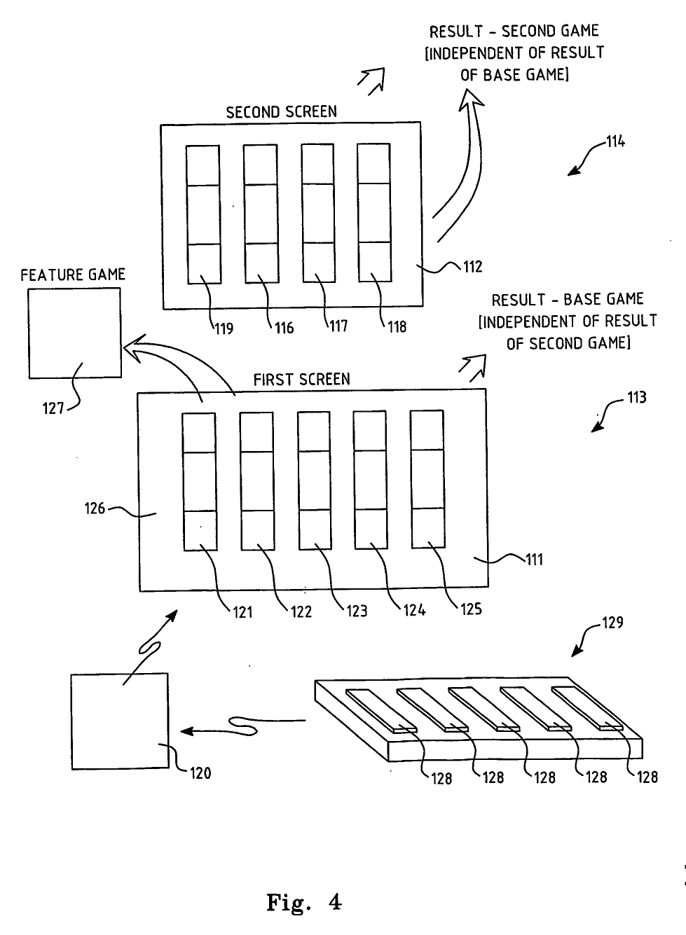

With reference to FIG. 4 there is illustrated a first display or screen 111 in association with a second display or screen 112 and mounted in a gaming machine (not shown). These screens are utilised to display progress and results of games in accordance with an example of an embodiment of the present invention as will now be described:

First screen 111 displays an array of five simulated reels comprising first reel 121, second reel 122, third reel 123, fourth reel 124 and fifth reel 125. During a play of a base game 113 in accordance with rules programmed into game controller 120 symbols 126 are caused to appear to rotate on each reel as the game progresses and finally come to a stop at termination of the game 113 at which time an alignment of symbols 126 is evident to the player (not shown). The specific alignment of symbols 126 will denote a result 126 for base game 113 in accordance with the specific rules of that game as programmed into game controller 120. The result 126 may be one of the following:
1. A nil result;
2. An award of a respin (typically of some of the reels only);
3. An award of credits for use in subsequent games;
4. A feature game 127;

The feature game 127, in this example, displays its progress as an animation superimposed on the reels 121-125 on first display 111.

In a stand-alone EGM (electronic gaming machine) having only a single display screen a typical probability of a feature game 127 being awarded as the result of a play of the base game 113 only is in the region of 1:100 to 1:150. In this example, however, a second screen 112 is utilised to display the progress of and at least part of the outcomes of a second game 114 which is also controlled by controller 120 and which can interact with the base game 113 in a way whereby, in this example, the probability of a feature game 127 on base 113 being awarded is improved from the player perspective to a probability in the range 1:50 to 1:00 and, more specifically in this particular example to a probability of 1:76.

In this particular example return to player of turnover is set at 60% for the base game and 30% for the feature game played on the base game leaving 10% for the house.

In this example the second game 114 is triggered by a player (not shown) at the same time as the base game 113 is triggered or initiated, in this instance, by the player pressing a play button 128 from an array 129 of play buttons 128, the pressing of which is signaled to game controller 120 thereby to initiate a play of both the base game 113 and second game 114 substantially simultaneously.

In this example the operation of the second game and display of its progress on second screen 114 is substantially as indicated in the flowchart of FIG. 3 and wherein like components are numbered as for the embodiment previously described with reference to FIG. 2 but numbered in the 100 series.

The above describes only some embodiments and examples of the present invention and modifications, obvious to those skilled in the art, can be made thereto without departing from the scope and spirit of the invention.

1. A gaming machine operable to play a base game and a second game; said gaming machine including a first display adapted to display progress and results of said base game; said gaming machine further including a second display adapted to display progress and results of said second game; said base game and said second game arranged to be played such that selected ones of outcomes of said second game affect play of said base game, whilst the outcome of said second game is independent of the outcome of said base game.

2. The gaming machine of claim 1 wherein said base game and said second game are initiated substantially simultaneously.

3. The gaming machine of claim 1 wherein a win conferred by said second game can award one or more of the following directly to said base game:
i. A nil result;
ii. A cash jackpot award;
iii. An award of a re-spin;
iv. An award of credits for use in subsequent games;
V. A feature game on the base game;
vi. Free games or bonus game on said base game;
vii. An award of base game symbols in conjunction with a re-spin of the base game.

4. The gaming machine of claim 1 wherein a win conferred by said second game can award a feature game to be played in said second display the outcome of which can award one or more of the following to said base game:
i. A nil result;
ii. A cash jackpot award;
iii. An award of a re-spin;
iv. An award of credits for use in subsequent games;
v. A feature game on the second game;
vi. Free games or bonus game on said base game;
vii. An award of base game symbols in conjunction with a re-spin of the base game.

5. The gaming machine of claim 1 wherein said base game is a symbol-driven game.

6. The gaming machine of claim 1 wherein said second game is a symbol-driven game.

7. The gaming machine of claim 5 wherein the coming to rest of symbols of said first game is sequentially controlled.

8. The gaming machine of claim 5 wherein the coming to rest of symbols of said second game is sequentially controlled.

9. The gaming machine of claim 1 wherein sequencing of progress of said second game is interleaved with sequencing of progress of said first game.

10. The gaming machine of claim 1 wherein said second game is paused when a winning combination of the second game is approached.

11. The gaming machine of claim 10 wherein said second game remains paused until said base game terminates.

12. The gaming machine of claim 1 wherein said play of said base game comprises a play of an initial game together with a play of any awarded feature games or bonus games or the like.

13. The gaming machine of claim 1 wherein said base game includes an array of either 3 or 4 or 5 or 6 reels.

14. The gaming machine of claim 1 wherein said second game includes a three reel array together with a fourth reel adapted to display an openable aperture.

15. The gaming machine of claim 14 wherein each reel of the reels of said three reel array is divided into a number of sectors displayed on the circumferences of each said reel and wherein each said reel is provided with a symbol in at least one of said sectors.

16. The gaming machine of claim 15 wherein a winning combination for said second game occurs when three symbols are aligned on a centre line of said three reel array and any symbol is displayed in said openable aperture of said fourth reel.

17. The gaming machine of claim 11 wherein a win is determined according to a predetermined disposition of said symbols of said three reel array when said three reel array has reached a stationary state at the end of said second game.

18. The gaming machine of claim 14 wherein the five reels of said base game and the reels of said second game are induced to spin at the start of said base game, and said openable aperture of said second game opens to reveal a symbol.

19. The gaming machine of claim 1 wherein a feature game is awarded thereon and has its progress and outcome displayed on said first display; said feature game having an increased probability of award as a result of initiation of a play of both said base game and said second game substantially simultaneously as compared with initiation of said base game only.

20. A method of increasing probability of an award of a feature game, said method comprising:
a) Providing a base game and a second game on an Electronic Gaming Machine together with a first display for displaying progress and results of said base game and a second display for displaying progress and results of said second game;
b) Causing a play of said second game to be triggered when a play of said base game is initiated.
c) Allowing selected ones of outcomes of said second game to affect play of said base game whilst the outcome of said second game is maintained independent of the outcome of said base game.
